(19) United States
(12) Patent Application Publication
(10) Pub. No.: US 2025/0179358 A1
(43) Pub. Date: Jun. 5, 2025

(54) PHOSPHOR AND METHOD FOR PRODUCING SAME

(71) Applicant: Mitsui Mining & Smelting Co., Ltd., Tokyo (JP)

(72) Inventors: Kazuma YOSHIDA, Ageo (JP); Masaaki INAMURA, Ageo (JP); Kentaro SOMA, Ageo (JP); Ryutaro OHASHI, Ageo (JP); Yasunori TABIRA, Ageo (JP)

(21) Appl. No.: 18/840,573

(22) PCT Filed: Feb. 22, 2023
(86) PCT No.: PCT/JP2023/006598

§ 371 Date: Aug. 22, 2024

(30) Foreign Application Priority Data
Mar. 31, 2022 (JP) 2022-060853

(51) Int. Cl. C09K 11/77

(52) U.S. Cl. CPC C09K 11/7731

(57) ABSTRACT

Provided is a phosphor coated with aluminum oxide, wherein when peak separation is performed on a ¹H-NMR spectrum of the phosphor in a range where a ¹H chemical shift value is from 0.5 to 11 ppm, peaks 1, 2 and 3 are obtained. Peak 1 has a top at a ¹H chemical shift value of 4.0 to 5.5 ppm, peak 2 has a top at a ¹H chemical shift value of 2.0 to 2.8 ppm, and peak 3 has a top at a ¹H chemical shift value of 0.5 to 1.5 ppm. A ratio S₂/(S₁+S₂+S₃) is 0.39 or less, wherein S₁ represents an integral value of peak 1 in a range where a ¹H chemical shift value is from −2 to 12 ppm, S₂ represents an integral value of peak 2 in the same range, and S₃ represents an integral value of peak 3 in the same range.

### CROSS REFERENCE TO RELATED APPLICATIONS

This application is a 371 U.S. National Phase of International Application No. PCT/JP2023/006598, filed on Feb. 22, 2023, which claims priority to Japanese Patent Application No. 2022-060853, filed Mar. 31, 2022. The entire disclosures of the above applications are incorporated herein by reference.

### BACKGROUND

### Technical Field

The present invention relates to a phosphor and a method for producing the same.

### Related Art

Various light-emitting devices with a wide color reproduction range have been developed in which, for example, a blue light-emitting diode (LED) is used as a light source and is combined with a phosphor emitting green fluorescence and that emitting red fluorescence. The phosphors are required to have high moisture resistance, specifically, to have the luminous intensity that is not deteriorated even when exposed to high humidity. One method to improve the moisture resistance of the phosphors is to coat the phosphor surface with an inorganic material by atomic layer deposition (ALD). Such technique is described in US 2012/199793A1, for example.

US 2012/199793A1 discloses phosphor particles coated with an inorganic material by ALD. According to the technique described in this literature, an inorganic material thinly coats the phosphors through several tens of cycles of ALD, to improve the moisture resistance of the phosphors.

In the technique described in US 2012/199793A1, the coating is formed through the above-described number of cycles of ALD to ensure moisture resistance while preventing a decrease in luminous intensity; however, it is still difficult to say that sufficient moisture resistance has been ensured.

Thus, an object of the present invention is to provide a phosphor with excellent moisture resistance even with a thin coating, and a method for producing the same.

### SUMMARY

The present invention is directed to a phosphor coated with aluminum oxide, wherein when peak separation is performed on a ¹H-NMR spectrum of the phosphor in a range where a ¹H chemical shift value is from 0.5 to 11 ppm, a peak 1, a peak 2, and a peak 3 are obtained, wherein the peak 1 is a peak having a peak top at a ¹H chemical shift value of 4.0 to 5.5 ppm, the peak 2 is a peak having a peak top at a ¹H chemical shift value of 2.0 to 2.8 ppm, and the peak 3 is a peak having a peak top at a ¹H chemical shift value of 0.5 to 1.5 ppm, and
a ratio S₂/(S₁+S₂+S₃) is 0.39 or less,
wherein S₁ represents an integral value of the peak 1 in a range where a ¹H chemical shift value is from −2 to 12 ppm,
S₂ represents an integral value of the peak 2 in the same range,
S₃ represents an integral value of the peak 3 in the same range, and
the ratio S₂/(S₁+S₂+S₃) is a ratio of S₂ to the sum of S₁, S₂, and S₃.

The present invention is also directed to a phosphor coated with aluminum oxide, wherein in a one-dimensional graph plotting an average diffraction intensity against a magnitude Q of a scattering vector, a ratio S₄/BG₄ is 0.09 or more, wherein S₄ represents an integral value of a peak in a range where Q is from 17 to 26 nm⁻¹ and BG₄ represents an integral value of a background signal in the same range,
wherein the one-dimensional graph is created by obtaining an electron diffraction pattern of the phosphor by nanobeam electron diffractometry using a transmission electron microscope and averaging diffraction intensities in a radial direction from a center of a transmission spot.

The present invention is further directed to a method for producing a phosphor coated with aluminum oxide, including coating a phosphor as a base material with aluminum oxide by atomic layer deposition, and then heating the resultant at 200 to 800° C.

### BRIEF DESCRIPTION OF THE DRAWINGS

FIG. 1 shows a ¹H-NMR chart of a sample from the phosphor obtained in Example 3.

FIG. 2 shows the one-dimensional graph plotting an average diffraction intensity against a magnitude Q of a scattering vector, and a background signal thereof. The graph in FIG. 2 was created by obtaining an electron diffraction pattern of a sample from the phosphor obtained in Example 2 by nanobeam electron diffractometry using a transmission electron microscope and averaging the diffraction intensities in the radial direction from the center of a transmission spot.

### DETAILED DESCRIPTION

Hereinafter, the present invention will be described based on its preferred embodiments. The phosphor of the present invention is coated with aluminum oxide. Since aluminum oxide has excellent water vapor barrier properties, coating the phosphor with aluminum oxide provides excellent moisture resistance. In particular, coating a phosphor having a specific surface area as described later with aluminum oxide is useful in view of improving the moisture resistance.

Herein, the term “phosphor” means a phosphor before being coated with aluminum oxide and/or a phosphor after being coated with aluminum oxide, depending on the context.

Herein, the term “aluminum oxide” refers to aluminum compounds represented by the compositional formula Al₂O₃ and aluminum oxides having at least an oxo ligand (O²⁻) as a ligand. Even aluminum compounds having a ligand other than an oxo ligand, such as a hydroxo ligand (OH) or an alkyl ligand, are encompassed in the aluminum oxide if they have an oxo ligand.

There are no particular limitations on the phosphor used in the present invention, and various types of conventionally known phosphors can be used. Example thereof include sulfide phosphors, halogen silicate phosphors, nitride phosphors, and oxide phosphors, and these can be used singly or in a combination of two or more thereof.

Examples of the sulfide phosphors include MGa₂S₄ (wherein M is a monovalent or divalent metal element), CaS, ZnS, (ZnCd)S, (CaSr)S, La₂O₂S, Y₂O₂S, Gd₂O₂S, and SrS.

Examples of luminescent centers of the sulfide phosphors include europium (Eu), cerium (Ce), manganese (Mn), and samarium (Sm).

Examples of the halogen silicate phosphors include MSiX₆:Mn (wherein M is one or more selected from Li, Na, and K; X is one or more selected from F, Cl, Br, and I; Si can be partially replaced with Ge; and Mn is a luminescent center).

Examples of the nitride phosphors include M₂Si₅N₈:Eu, MAlSiN₃:Eu, MSi₇N₁₀:Eu, M_{1.8}Si₅O_{0.2}N₈:Eu, M_{0.9}Si₇O_{0.1}N₁₀:Eu, and MSi₂O₂N₂:Eu (wherein M is one or more selected from Sr, Ca, Ba, Mg, and Zn).

Examples of the oxide phosphors include M¹₂₋ₓM²ₓO₃ (wherein M¹ and M² are each independently one selected from Sc, Y, La, Pr, Sm, Eu, Gd, Tb, Dy, Ho, Er, and Tm, and x is 0 to 2), ZnO, and ZnGa₂O₄.

In the present invention, it is preferable to use a sulfide phosphor as the phosphor because it has a half width and peak wavelength of the emission spectrum suitable for providing light-emitting devices with high luminous intensity and high color reproducibility. In particular, it is more preferable to use MGa₂S₄ (wherein M is a monovalent or divalent metal element) with use of Eu as the luminescent center, and even more preferable to use SrGa₂S₄:Eu as the sulfide phosphor.

One aspect of the present invention is characterized by the ¹H-NMR spectrum of the phosphor. Specifically, when peak separation is performed on the ¹H-NMR spectrum of the phosphor in the range where the ¹H chemical shift value is from 0.5 to 11 ppm, a peak 1, a peak 2, and a peak 3 are obtained, wherein the peak 1 is a peak having a peak top at a ¹H chemical shift value of 4.0 to 5.5 ppm, the peak 2 is a peak having a peak top at a ¹H chemical shift value of 2.0 to 2.8 ppm, and the peak 3 is a peak having a peak top at a ¹H chemical shift value of 0.5 to 1.5 ppm; and the ratio S₂/(S₁+S₂+S₃) is 0.39 or less, wherein S₁ represents the integral value of the peak 1 in the range from the point where the ¹H chemical shift value is closest to −2 ppm to the point where the ¹H chemical shift value is closest to 12 ppm, S₂ represents the integral value of the peak 2 in the aforementioned range, S₃ represents the integral value of the peak 3 in the aforementioned range, and the ratio S₂/(S₁+S₂+S₃) is the ratio of S₂ to the sum of S₁, S₂, and S₃. Herein, the term “point where the ¹H chemical shift value is closest to X (ppm)” refers to the spectral point where the ¹H chemical shift value is closest to X (ppm) among all spectral points constituting the ¹H-NMR spectrum. The phrase “from the point where the ¹H chemical shift value is closest to −2 ppm to the point where the ¹H chemical shift value is closest to 12 ppm” is hereinafter also simply referred to as “from −2 to 12 ppm” for the sake of convenience.

For example, a plurality of peaks each having a peak top in the range of 4.0 to 5.5 ppm, which is the range of the peak 1, may be exhibited. In such cases, the sum of all peaks each having a peak top in this range is referred to as the peak 1 herein. The same also applies to the peak 2 and the peak 3. Namely, if a plurality of peaks each having a peak top in the specified range are obtained, the sum of all of them is referred to as the peak 1, the peak 2, or the peak 3.

Note that each chemical shift value range mentioned above is a chemical shift value range obtained by performing measurement at room temperature (21 to 25° C.) using a nuclear magnetic resonator at a resonance frequency of ¹H nucleus of 600 MHZ, and correcting the result with respect to the peak top of the ¹H spectrum of adamantane powder sample (1.91 ppm), as an external standard, obtained by the MAS method at a sample rotation speed of 60 kHz.

The ¹H-NMR spectrum of a phosphor may be a complex spectrum with a plurality of overlapping peaks, and it is therefore necessary to separate the peaks of the spectrum in the range where a chemical shift value is from 0.5 to 11 ppm. This peak separation enables accurate calculation of the integral values S₁ to S₃.

The ¹H MAS NMR spectrum (herein, also simply referred to as “¹H-NMR spectrum”) can be obtained, for example, under the following conditions.
Magnetic field: 14.1 T (¹H 600 MHZ)
Spectrometer: AVANCE NEO600, manufactured by Bruker
Software for measurement and data processing: TopSpin, manufactured by Bruker
NMR probe: 1.3 mm MAS probe
Rotation speed of sample: 60 kHz
Standard sample for chemical shift values and radio wave intensity: adamantane
Standard for chemical shift values: The central peak of adamantane is 1.91 ppm when measured by the MAS method at a rotation speed of the sample of 8 kHz.
Spectral center (O1 value-SR value (chemical shift notation)): 4.7 ppm Pulse intensity of radio wave: The value at which the pulse width that maximizes the peak of adamantane when the spectral center is 1.91 ppm is 2.5 μs.
Pulse width of radio wave: 2.5 μs
Measurement interval: 2.0 μs (DW=1.0 μs on the above-mentioned software)
Number of measurement points: 10,000 (TD=20,000 on the above-mentioned software)
Number of spectral points (SI on the above-mentioned software): 65536

A spectrum obtained under the measurement conditions mentioned above is subjected to baseline correction on calculation software, and then the background spectrum, which will be described later, is subtracted from the resulting spectrum to obtain a ¹H MAS NMR spectrum. The baseline is formed by connecting the points of arithmetic means of chemical shift values and signal intensities of all points from a point where the ¹H chemical shift value is closest to 11.5 ppm to a point where the ¹H chemical shift value is closest to 12 ppm and the points of arithmetic means of chemical shift values and signal intensities of all points from a point where the ¹H chemical shift value is closest to −0.25 ppm to a point where the ¹H chemical shift value is closest to 0.25 ppm.

The spectrum obtained in this manner is hereinafter referred to as an “H actual spectrum”. The above-described peaks 1 to 3 are obtained by performing peak separation of the H actual spectrum. The peak separation is performed by fitting a calculated spectrum created by summing the pseudo-Voigt function for the number of peaks to the H actual spectrum in the range where a ¹H chemical shift value is from 0 to 6.5 ppm. The pseudo-Voigt function is the sum of the Lorentzian function and the Gaussian function with the same full width at half maximum. The pseudo-Voigt function f(x) used in the peak separation is shown in Equation (1) below. The peak integral value of each peak is obtained by summing signal intensities of peaks calculated by the pseudo-Voigt function at points from −2 to 12 ppm in the H actual spectrum.

The “pseudo-Voigt function” is based on “6. Profile Functions and Pattern Decomposition Method” in “Special Issue-New Evolution of the Powder Diffraction Method”, Journal of the Crystallographic Society of Japan, 34, 86 (1992).

The background spectrum used to obtain the aforementioned spectrum is calculated in the following manner. A phosphor powder sample not coated with aluminum oxide is used as a blank sample, and this blank sample is analyzed by 1H-MAS NMR under the measurement conditions described above. The result of the measurement of the blank sample is subjected to baseline correction under the conditions described above, and the resulting spectrum is used as the spectrum of the blank sample, which is subjected to peak separation using the pseudo-Voigt function in the same manner as described above. Among the peaks obtained through the peak separation, peaks that are likely to indicate water or hydration water, which have a peak top within a chemical shift value of 4.5 to 5.0 ppm, are all deleted, and the sum spectrum obtained by adding all other peaks is used as the background spectrum. In order to minimize the subtraction error, the spectrum of the blank sample from which the background spectrum is obtained should be obtained on the same day as, or as close as possible to, the date when the spectrum of each sample from which the background spectrum is subtracted is obtained.

In a case of a phosphor already coated with aluminum oxide, the phosphor may be treated with an alkali such as sodium hydroxide solution to remove the aluminum oxide, and then washed and dried to remove the aluminum oxide and alkali residue, and then the resulting phosphor may be used in the same manner as described above to obtain a background spectrum.

$$\begin{matrix}[ Math . 1 ] & \\ f ( x ) = S \cdot \{ η \cdot \frac{2}{H π} \cdot \frac{1}{1 + 4 {( \frac{x - {x}_{0}}{Δ} )}^{2}} + ( 1 - η ) \cdot \frac{2}{Δ} {( \frac{ln 2}{π} )}^{\frac{1}{2}} \cdot exp [ - 4 ln 2 {( \frac{x - {x}_{0}}{Δ} )}^{2} ] \} & ( 1 )\end{matrix}$$

In Equation (1), x represents a value (chemical shift value) on the horizontal axis of a ¹H MAS NMR spectrum, x₀ represents a chemical shift value at the peak top, S represents a scaling factor to match the value on the vertical axis at a peak to the actual measurement, η represents a peak area ratio of the Lorentzian function (first term) from −∞ (minus infinity) to +∞ (plus infinity), Δ represents a full width at half maximum at a peak, x represents the number pi, ln represents the natural logarithmic function, and exp represents the natural exponential function.

In the peak separation, fitting is performed using the solver function of the calculation software so as to minimize the root mean square deviation between the actual spectrum and the calculated spectrum in a range where a chemical shift value is from 0 to 6.5 ppm, using x₀, Δ, η, and S as variables for each pseudo-Voigt function for the number of peaks.

Most phosphors coated with aluminum oxide have an Al—OH moiety on the phosphor surface. The peak 1 mentioned above is a peak assigned to the Al—OH moiety.

On the other hand, when phosphors coated with aluminum oxide are heated at a certain temperature, as in the exemplary production method described below, the Al—OH moiety is dehydrated, and instead an Al—O—Al crosslinked moiety is formed on the phosphor surface. When many Al—O—Al crosslinked moieties are present on the phosphor surface, the aluminum oxide coating layer on the phosphor surface is stronger with fewer gaps, and accordingly, the phosphor has improved moisture resistance.

Namely, for obtaining a phosphor with great moisture resistance, it is preferable to increase the percentage of Al—O—Al crosslinked moieties while decreasing the percentage of Al—OH moieties. As described above, the peak 2 is a peak assigned to the Al—OH moiety, and thus when a ratio of the integral value S₂ of the peak 2 to the sum of the integral value S₁ of the peak 1, the integral value S₂ of the peak 2, and the integral value S₃ of the peak 3, S₂/(S₁+S₂+S₃), is 0.39 or less, the percentage of Al—O—Al is large. This indicates that the fluorophore has excellent moisture resistance. Although depending on the method for producing the phosphor, the peak 3 is a peak assigned to, for example, an Al—CH₂ or Al—CH₃ moiety.

From such a viewpoint, S₂/(S₁+S₂+S₃) is more preferably 0.35 or less, even more preferably 0.2 or less, and even more preferably 0.1 or less, and the lower limit is 0.

Another aspect of the present invention is characterized by the one-dimensional graph plotting an average diffraction intensity against a magnitude Q of a scattering vector, from an electron diffraction pattern of the phosphor of the present invention. Specifically, the one-dimensional graph is created by obtaining an electron diffraction pattern of the phosphor of the present invention by nanobeam electron diffractometry using a transmission electron microscope and averaging the diffraction intensities in the radial direction from the center of a transmission spot. In the one-dimensional graph, a ratio S₄/BG₄ is preferably 0.09 or more, wherein S₄ represents the integral value of a peak in a range where Q is from 17 to 26 nm⁻¹ and BG₄ represents the integral value of a background signal in the same range. In the phosphor of the present invention, the aluminum oxide for coating the phosphor is preferably amorphous. In other words, the aluminum oxide for coating the phosphor of the present invention preferably has a chemical structure that is less ordered than that of a crystalline structure. However, a ratio S₄/BG₄ of 0.09 or more indicates that the orderliness of the interatomic distances in the range of 1 nm or less of aluminum oxide is increased. The reason for the increased orderliness of the interatomic distances in the range of 1 nm or less is as follows, for example: when a phosphors is produced by the exemplary production method, which will be described later, the Al—OH moiety on the phosphor surface decreases due to dehydration so that the percentage of Al—O—Al crosslinked moieties increases, and thus the proportion of interatomic distances resulting from the Al—O—Al crosslinked moieties increases.

When such crosslinked moieties are abundant on the phosphor surface, the aluminum oxide coating layer covering the phosphor surface is stronger with fewer gaps, and the phosphor has improved moisture resistance.

The upper limit of S₄/BG₄ is not particularly limited, but it is generally about 100.

The background signal can be obtained by drawing a common tangent line straddling the front and back of the shoulder of the curve that appears in the intensity profile in the one-dimensional graph and using it as the background function.

The phosphor of the present invention has a specific surface area of preferably 1 to 10 m²/g, more preferably 1 to 5 m²/g, and even more preferably 1 to 3 m²/g, as measured on the phosphor coated with aluminum oxide.

The phosphor having a specific surface area of 1 m²/g or more is suitable for applications that require small particle size, such as micro-LEDs and mini-LEDs. When the specific surface area is 10 m²/g or less, the phosphor particles with coating include less neck growth therebetween.

The specific surface area can be measured according to “(3.5) One-point method” of “6.2 Flow method” in JIS R 1626 “Measuring methods for the specific surface area of fine ceramic powders by gas adsorption using the BET method” using a specific surface area analyzer (e.g., HM model-1210 manufactured by Mountech Co., Ltd.) with a nitrogen/helium mixed gas containing 30% by volume of nitrogen as the adsorption gas and 70% by volume of helium as the carrier gas.

In both of the above-described aspects, the phosphor has an aluminum content of preferably 10000 to 100000 ppm, more preferably 15000 to 80000 ppm, and even more preferably 20000 to 60000 ppm. When the aluminum content is 10000 ppm or more, the phosphor can have sufficiently improved moisture resistance.

The aluminum content refers to an aluminum content as measured by ICP emission spectrometry.

Next, a method for producing the phosphor of the present invention will be described. The phosphor of the present invention is obtained, for example, by coating a phosphor with aluminum oxide by ALD, and then heating the resultant. The ALD used in the present invention provides good step coverage, and the phosphor has thus excellent moisture resistance, even when coating is so thin that the performance of the phosphor is not impaired. When producing the phosphor of the present invention by this method, the ALD process can be carried out in the follows manner, for example.
(a) Placing a phosphor as the base material in a reaction vessel.
(b) Introducing trimethylaluminum vapor into the reaction vessel.
(c) Purging the trimethylaluminum vapor and byproducts of the reaction.
(d) Introducing water vapor into the reaction vessel.
(e) Purging the water vapor and byproducts of the reaction.
(f) Repeating steps (b) to (e).

The type of the phosphor as the base material used in step (a) is as described above.

In step (b), trimethylaluminum, which is a precursor of aluminum oxide, is used to coat the phosphor as the base material with aluminum oxide, or alternatively, it is also possible to use aluminum ethoxide or aluminum isopropoxide.

In steps (c) and (e), nitrogen or argon can be used for the purging, for example.

In the present invention, water vapor is used in step (d) to oxidize the precursor. Alternatively or additionally, it is also possible to use ozone.

In the present invention, the number of repetitions (or in other words, cycles) in step (f) is preferably from 10 to 150, more preferably from 20 to 120, and even more preferably from 25 to 80. When the number of repetitions is 10 or more, a phosphor with sufficient moisture resistance can be obtained. When the number of repetitions is 150 or less, the production cost of the phosphor of the present invention can be kept low, and the production time can be also shortened.

Next, the heat treatment after coating will be described. The heat treatment of the phosphor after coating can convert Al—OH moieties on the phosphor surface to Al—O—Al crosslinked moieties through a dehydration reaction. As described above, the Al—O—Al crosslinked moieties improves the moisture resistance of the phosphor, and thus the heat treatment has the effect of improving the moisture resistance of the phosphor.

The heat treatment is performed at preferably 200 to 800° C., more preferably 300 to 700° C., and even more preferably 500 to 650° C. When the heat treatment is performed at 200° C. or more, the moisture resistance of the phosphor can be sufficiently enhanced. When the heat treatment is performed at 800° C. or less, the progression of side reactions due to heating can be suppressed, and a phosphor with excellent emission intensity and moisture resistance can be obtained.

The heating temperature may be constant throughout the heat treatment or may be varied over time within the temperature range mentioned above.

The heat treatment can be performed in an inert gas atmosphere such as nitrogen or argon or in an oxidizing gas atmosphere such as air. In particular, it is preferable to perform the heat treatment in an inert gas atmosphere to prevent oxidation of the phosphor and to enhance the moisture resistance of the phosphor. Among the various inert gases, nitrogen is particularly preferable in terms of cost reduction.

The heat treatment can also be performed under reduced pressure in the atmosphere as mentioned above. Alternatively, the heat treatment can be performed under vacuum.

The phosphor of the present invention can be combined with any of various LEDs including micro LEDs and mini LEDs to be used as a light emitting device. Since the phosphor of the present invention has excellent moisture resistance, it can be suitably used under high humidity conditions.

With respect to the above-described embodiments, the present invention further discloses the following phosphor and method for producing the same.

[1] A phosphor coated with aluminum oxide, wherein when peak separation is performed on a ¹H-NMR spectrum of the phosphor in a range where a ¹H chemical shift value is from 0.5 to 11 ppm, a peak 1, a peak 2, and a peak 3 are obtained, wherein the peak 1 is a peak having a peak top at a ¹H chemical shift value of 4.0 to 5.5 ppm, the peak 2 is a peak having a peak top at a ¹H chemical shift value of 2.0 to 2.8 ppm, and the peak 3 is a peak having a peak top at a ¹H chemical shift value of 0.5 to 1.5 ppm, and
a ratio S₂/(S₁+S₂+S₃) is 0.39 or less,
wherein S₁ represents an integral value of the peak 1 in a range where a ¹H chemical shift value is from −2 to 12 ppm,
S₂ represents an integral value of the peak 2 in the same range,
S₃ represents an integral value of the peak 3 in the same range, and
the ratio S₂/(S₁+S₂+S₃) is a ratio of S₂ to the sum of S₁, S₂, and S₃.
   [2] A phosphor coated with aluminum oxide, wherein in a one-dimensional graph plotting an average diffraction intensity against a magnitude Q of a scattering vector, a ratio S₄/BG₄ is 0.09 or more,
wherein S₄ represents an integral value of a peak in a range where Q is from 17 to 26 nm⁻¹ and
BG₄ represents an integral value of a background signal in the same range,
wherein the one-dimensional graph is created by obtaining an electron diffraction pattern of the phosphor by nanobeam electron diffractometry using a transmission electron microscope and averaging diffraction intensities in a radial direction from a center of a transmission spot.
   [3] The phosphor as set forth in [1] or [2], wherein the aluminum oxide is amorphous.
   [4] The phosphor as set forth in any one of [1] to [3], wherein the phosphor has a specific surface area of 1 to 10 m²/g.
   [5] The phosphor as set forth in any one of [1] to [4], wherein the phosphor has an aluminum content of 10000 to 100000 ppm as measured by ICP emission spectrometry.
   [6] A method for producing a phosphor coated with aluminum oxide, including coating a phosphor as a base material with aluminum oxide by atomic layer deposition, and then heating the resultant at 200 to 800° C.

### EXAMPLES

The invention will be described in more detail by way of Examples. However, the scope of the invention is not limited to these examples.

### Examples 1 to 4 and Comparative Examples 1 to 3

### Production of Phosphor

SrGa₂S₄:Eu, which is a sulfide phosphor, was placed in an ALD reaction vessel and heated to 120° C. Then, trimethylaluminum vapor and water vapor, which were reactants, were introduced alternately with nitrogen purge interposed therebetween. The introduction of the two reactants was regarded as one cycle, and the introduction cycle of the reactants was repeated for the number of times shown in Tables 1 to 3.

Next, the coated phosphor was heated to obtain phosphor samples of Examples. The heat treatment was performed in a nitrogen atmosphere at the temperatures shown in Tables 1 to 3. On the other hand, the heat treatment was not performed in Comparative Examples 1 to 3.

### Measurement of Aluminum Content

For each of Examples and Comparative Examples, the aluminum content of the sample was measured using an ICP optical emission spectrometer (PS3520UVDDII manufactured by Hitachi High-Tech Science Corporation).

### Evaluation of Moisture Resistance

For each of Examples and Comparative Examples, the sample was mixed with silicone resin (OE-6630 manufactured by Dow Toray Co., Ltd.) in an amount of 40 wt % with respect to the resin, and the mixture was applied to a glass plate to a thickness of approximately 300 μm, and thermally cured at 140° C. for one hour. The specimen thus prepared was used for evaluation of moisture resistance.

Specifically, the external quantum efficiency of the specimen was determined before and after the HAST (High Accelerated Stress Test), and the moisture resistance was evaluated in terms of the retention rate (%) of the external quantum efficiency calculated by dividing the external quantum efficiency after HAST by that before HAST.

The HAST was performed in accordance with IEC68-2-66, and specifically, the specimen was stored in a saturated PCT container (120° C., 100% RH) for 24 hours in principle. However, in Examples 3 and 4 and Comparative Example 3, in which the luminescence retention after 24 hours was 94% or more, the luminescence retention after 48 hours HAST was also determined.

The external quantum efficiency was determined using a spectrofluorometer (FP-8500 manufactured by JASCO Corporation).

### ¹H-NMR Analysis

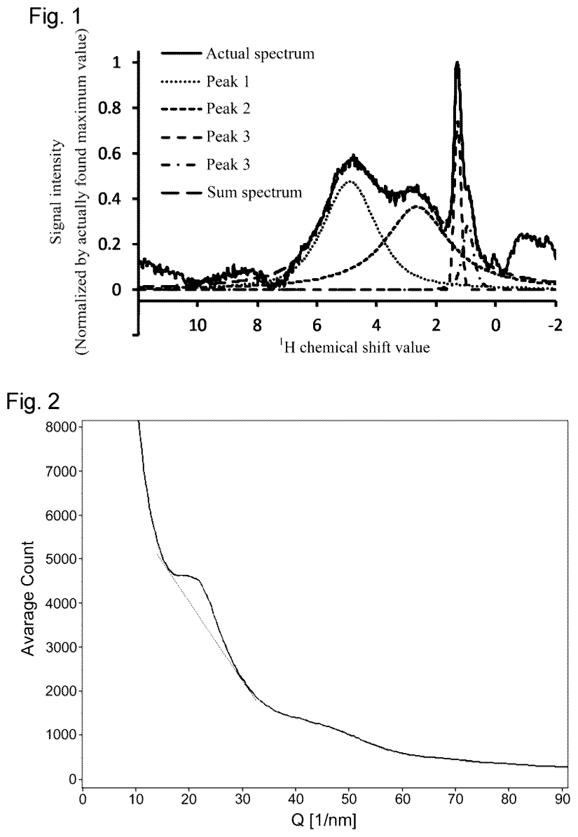

An ¹H-NMR spectrum of each sample of Examples and Comparative Examples was obtained by the above-described method. Then, peak separation of the NMR spectrum obtained was performed in a range where a ¹H chemical shift value is from 0.5 to 11 ppm. FIG. 1 shows the ¹H-NMR spectrum after peak separation in Example 3.

The integral values S₁, S₂, and S₃ were obtained from the NMR spectrum after peak separation, and the ratio S₂/(S₁+S₂+S₃) was calculated. Tables 1 to 3 show the values of S₂/(S₁+S₂+S₃) in Examples and Comparative Examples.

### Nanobeam Electron Diffractometry (NBD)

The sample was mixed with thermosetting resin (G2, manufactured by Gatan), and the resulting mixture was defoamed at 50° C. under vacuum, and heated to 120° C. under vacuum to cure. The cured product was thinned with a Ga ion beam at an acceleration voltage of 30 kV using a focused ion beam/scanning electron microscope combined system (Scios2, manufactured by Thermo Fisher Scientific Inc.) to obtain a sample for measurement. Next, an electron diffraction pattern was obtained using a transmission electron microscope (TEM, JEM-2100F manufactured by JEOL) and its accompanying instruments, ASTAR manufactured by Nanomegas and Topspin manufactured by Nanomegas.

The conditions for electron diffractometry were as follows. The TEM was set up in the following conditions: acceleration voltage 200 kV, NBD mode, aα=3, beam diameter 1 nm, convergence aperture diameter 10 μm, and camera length 100 cm. The Topspin was set up in the following conditions: line scan mode, scanning interval of line scan 1 nm, number of pixels 580 pixels×580 pixels, exposure time 1 sec, without precession, and with drift correction.

The electron diffraction pattern obtained was processed by script Interactive Rotational Profile of TEM analysis software Gatan Digital Micrograph to calculate an average intensity in the radial direction centered on the direct spot, thereby creating a one-dimensional graph plotting an average diffraction intensity against a magnitude Q of a scattering vector. The background signal of this graph was obtained by drawing a common tangent line straddling the front and back of the shoulder of the curve that appeared in the intensity profile and using it as the background function. FIG. 2 shows the one-dimensional graph plotting an average diffraction intensity against a magnitude Q of a scattering vector, and the background signal thereof, in Example 2.

Then, the ratio S₄/BG₄ was calculated from the one-dimensional graph obtained as described above, wherein S₄ represents the integral value S₄ of a peak in a range where Q is from 17 to 26 nm⁻¹ and BG₄ represents the integral value of a background signal in the same range. Tables 1 to 3 show values of this ratio.

### Measurement of Specific Surface Area

For each of Examples and Comparative Examples, 0.1 to 0.2 g of the sample was weighed out to use for measurement. The specific surface area of the sample was measured by the nitrogen adsorption method (BET one-point method) using an “HM model-1210” manufactured by Mountech Co., Ltd. Tables 1 to 3 show results of the specific surface area.

TABLE 1

| | Number of | Heating | | Evaluation of moisture resistance | | | NBD | Specific |
|---|---|---|---|---|---|---|---|---|
| | times of | temper- | Al | Luminescence | Luminescence | ¹H-NMR | S₄/BG₄ | surface |
| | coating | ature | content | retention (%) | retention (%) | S₂/(S₁ + | (Q = 17 to | area |
| | (cycles) | (° C.) | (ppm) | after 24 hours | after 48 hours | S₂ + S₃) | 26 nm⁻¹) | (m²/g) |
| Ex. 1 | 25 | 300° C. | 18000 | 54 | — | 0 | 0.105 | 2.11 |
| Ex. 2 | 25 | 500° C. | 18000 | 84 | — | 0 | 0.101 | 2.22 |
| Com. Ex. 1 | 25 | No | 18000 | 8 | — | 0.4 | 0.074 | 2.46 |

TABLE 2

| | Number of | Heating | | Evaluation of moisture resistance | | | NBD | Specific |
|---|---|---|---|---|---|---|---|---|
| | times of | temper- | Al | Luminescence | Luminescence | ¹H-NMR | S₄/BG₄ | surface |
| | coating | ature | content | retention (%) | retention (%) | S₂/(S₁ + | (Q = 17 to | area |
| | (cycles) | (° C.) | (ppm) | after 24 hours | after 48 hours | S₂ + S₃) | 26 nm⁻¹) | (m²/g) |
| Ex. 3 | 40 | 500° C. | 23000 | 94 | 93 | 0.33 | 0.119 | 2.11 |
| Com. Ex. 2 | 40 | No | 23000 | 35 | — | 0.52 | 0.080 | 2.16 |

TABLE 3

| | Number of | Heating | | Evaluation of moisture resistance | | | NBD | Specific |
|---|---|---|---|---|---|---|---|---|
| | times of | temper- | Al | Luminescence | Luminescence | ¹H-NMR | S₄/BG₄ | surface |
| | coating | ature | content | retention (%) | retention (%) | S₂/(S₁ + | (Q = 17 to | area |
| | (cycles) | (° C.) | (ppm) | after 24 hours | after 48 hours | S₂ + S₃) | 26 nm⁻¹) | (m²/g) |
| Ex. 4 | 100 | 500° C. | 57000 | 98 | 98 | 0.05 | 0.096 | 2.02 |
| Com. Ex. 3 | 100 | No | 60000 | 102 | 90 | 0.56 | 0.085 | 2.02 |

As shown in Tables 1 to 3, the phosphors of Examples, in which heat treatment was performed after coating, exhibited greater moisture resistance than the phosphors of Comparison Examples, in which heat treatment was not performed though coating was formed through the same number of cycles. In other words, it is seen that a phosphor that has been subjected to heat treatment has superior moisture resistance even when it has thinner coating formed through a small number of coating cycles. Since the phosphors in Examples 3 and 4 and Comparative Example 3 exhibited high moisture resistance and therefore had luminescence retention of close to 100% after 24 hours HAST, the luminescence retention thereof after 48 hours HAST was determined as well in order to more accurately evaluate the moisture resistance. As a result, it was found that the phosphors of Examples 3 and 4, in which heat treatment was performed, exhibited greater moisture resistance than that of the phosphor of Comparative Example 3.

### INDUSTRIAL APPLICABILITY

The present invention provides a phosphor with excellent moisture resistance despite its thin coating, and a method for producing the same.

1. A phosphor coated with aluminum oxide, wherein when peak separation is performed on a ¹H-NMR spectrum of the phosphor in a range where a ¹H chemical shift value is from 0.5 to 11 ppm, a peak 1, a peak 2, and a peak 3 are obtained, wherein the peak 1 is a peak having a peak top at a ¹H chemical shift value of 4.0 to 5.5 ppm, the peak 2 is a peak having a peak top at a ¹H chemical shift value of 2.0 to 2.8 ppm, and the peak 3 is a peak having a peak top at a ¹H chemical shift value of 0.5 to 1.5 ppm, and
a ratio S₂/(S₁+S₂+S₃) is 0.39 or less,
wherein S₁ represents an integral value of the peak 1 in a range where a ¹H chemical shift value is from −2 to 12 ppm,
S₂ represents an integral value of the peak 2 in the same range,
S₃ represents an integral value of the peak 3 in the same range, and
the ratio S₂/(S₁+S₂+S₃) is a ratio of S₂ to the sum of S₁, S₂, and S₃.

2. A phosphor coated with aluminum oxide, wherein in a one-dimensional graph plotting an average diffraction intensity against a magnitude Q of a scattering vector, a ratio S₄/BG₄ is 0.09 or more,
wherein S₄ represents an integral value of a peak in a range where Q is from 17 to 26 nm⁻¹ and
BG₄ represents an integral value of a background signal in the same range,
wherein the one-dimensional graph is created by obtaining an electron diffraction pattern of the phosphor by nanobeam electron diffractometry using a transmission electron microscope and averaging diffraction intensities in a radial direction from a center of a transmission spot.

3. The phosphor according to claim 1, wherein the aluminum oxide is amorphous.

4. The phosphor according to claim 1, wherein the phosphor has a specific surface area of 1 to 10 m²/g.

5. The phosphor according to claim 1, wherein the phosphor has an aluminum content of 10000 to 100000 ppm as measured by ICP emission spectrometry.

6. A method for producing a phosphor coated with aluminum oxide, comprising coating a phosphor as a base material with aluminum oxide by atomic layer deposition, and then heating the resultant at 200 to 800° C.
